(19) United States
(12) Patent Application Publication
(10) Pub. No.: US 2010/0233452 A1
(43) Pub. Date: Sep. 16, 2010

(54) Sandwich Structure and Method of Producing Same

(75) Inventor: Ulrike Hoesch-Vial, Nideggen (DE)

Correspondence Address: PAUL AND PAUL, 2000 MARKET STREET, SUITE 2900, PHILADELPHIA, PA, 19103, US

(73) Assignee: POLYMERPARK TECHNOLOGIES GMBH + CO. KG, Aachen (DE)

(21) Appl. No.: 12/739,429

(22) PCT Filed: Oct. 9, 2008
(86) PCT No.: PCT/EP08/63566

§ 371 Date: Apr. 29, 2010

(30) Foreign Application Priority Data
Oct. 24, 2007 (DE) 10 2007 051 132.0

(51) Int. Cl. B32B 5/14; B29C 45/14; B29C 44/18; B32B 27/00; B32B 7/02

(52) U.S. Cl. 428/213; 264/261; 264/257; 264/46.5; 428/192

(57) ABSTRACT

The present invention concerns a method of producing a sandwich structure which is easy to produce and which has particular physical and/or chemical properties. To achieve that there is proposed a method of producing that sandwich structure which has the following steps:
a) introducing a first cover layer (3) into an injection molding mold,
b) introducing a second cover layer (3) into the injection molding mold,
c) closing the injection molding mold,
d) injecting a core material into the closed injection molding mold between the first and second cover layers (3) by means of injection molding,
e) hardening of the core material so that a core layer (2) is formed between the two cover layers (3), and
f) opening the injection molding mold and removing the sandwich structure (3) from the mold.

The present invention concerns a sandwich structure and a method of producing a sandwich structure.

Sandwich or multi-layer structures are used to a large extent in the most widely varying areas of use as they generally afford a high level of strength and stiffness in spite of being low in weight. They are used for example for load-bearing structural assemblies in lightweight construction.

Frequently sandwich structures comprise relatively stiff cover layers which are glued to a relatively light core material. When a sandwich element is bent the cover layers carry the tensile and compression forces while the core transmits the thrust forces.

A large number of such sandwich structures are made from plastic material as plastic materials are very low in density and are thus low in weight. For example plastic products based on thermosetting materials are known and they are combined with reinforcing polyester, polyurethane or epoxy glass fiber cover layers.

Those thermosetting sandwich structures are admittedly available in various design configurations and qualities but by virtue of their substance character they frequently cannot be recycled or can be recycled only with very great difficulty. In addition the toughness of those materials is very low.

In principle thermoplastic materials are superior to thermosetting materials in regard to toughness and recycling capability. Thermoplastic materials however hitherto generally require very high levels of installation investment costs for industrial production so that then large quantities have to be produced in order to be able to offer the sandwich structures at competitive prices. The known line installations in addition involve no or only a low level of process flexibility. Usually in that case mechanically load-bearing cover layers are thermally or chemically joined to the light core material. In that respect an existing finished core material is brought together with an existing finished cover layer. That process implementation involves a two-stage or multi-stage process which is expensive.

By way of example, such a complicated and expensive method is described in EP 0 794 859.

Starting from that state of the art therefore the object of the present invention is to provide a method of producing a sandwich structure which is simple and inexpensive to carry out and which allows flexible adaptation of the production process. Another object of the present invention is to provide a sandwich structure which is easy to produce and has particular physical and/or chemical properties.

That object is attained by a method of producing a sandwich structure which has the following steps:

a) introducing a first cover layer into an injection molding mold,

b) introducing a second cover layer into the injection molding mold,

c) closing the injection molding mold,

d) injecting a core material into the closed injection molding mold between the first and second cover layers by means of injection molding,

e) hardening of the core material so that a core layer is formed between the two cover layers, and

f) opening the injection molding mold and removing the sandwich structure from the mold.

Usually injection molding molds have at least two tool portions. In this case the first cover layer is introduced into the first tool portion while the second cover layer is introduced into the second tool portion. Measures are possibly taken to hold the cover layer in the injection molding mold. The injection molding mold is then closed and the core material is injected under pressure and generally at elevated temperature into the injection molding mold. After the material between the two cover layers has hardened to form a core layer the injection molding mold can be opened and the resulting sandwich structure can be removed from the mold.

In a particularly preferred embodiment the first and second cover layers are selected from the same material. In that case preferably they are of substantially the same thickness so that the result is a symmetrical sandwich structure. The first and/or second cover layers can comprise a polymer material, for example a thermosetting or thermoplastic material, thermoplastic plastic preferably being used here. As already mentioned in the opening part of this specification thermoplastic material enjoys better toughness and is generally easier to recycle.

Materials by way of example which can be considered for the cover layer are polypropylene (PP), polyethylene (PE), copolymers of PE and PP, polyamides, for example PA6 or PA66, copolymers of PA6, PA66 and/or PA12. It is further possible to use thermoplastic polyesters such as for example polyethylene terephthalate (PET), polybutylene terephthalate (PBT), acrylonitrile-butadiene-styrene copolymer (ABS) or styrene-acrylonitrile (SAN).

Thermoplastic elastomers have also proven to be particularly suitable such as for example thermoplastic polyurethane (TPU), PP with ethylene-propylene-diene rubber (EPDM) or also thermoplastic elastomers based on polyamide, polypropylene or polyethylene.

In addition the use of elastomers may be meaningful for many situations of use as they are particularly impact-resistant. Examples are elastomers based on polyamide or polyester.

In an alternative embodiment a metallic layer is adopted as the cover layer.

In the case of polymer material it is advantageous if the cover layer is fiber-reinforced, that is to say the first and/or the second cover layer comprises a fiber plastic composite material.

Such fiber plastic composite materials preferably comprise about 60% by weight of fibers which are introduced into about 40% by weight of a matrix material, namely the specified polymer materials.

By way of example it is possible to use single-layer or multi-layer, unidirectionally reinforced or cloth-reinforced long fiber composites. Non-crimp fabrics have proven to be particularly advantageous as the reinforcing material in the cover layer. The fibers can be glass, carbon, aramide, basalt or natural fibers such as for example jute, hemp or kenaf. It is also possible to use fibers of thermoplastic material such as for example PP, PE, copolymers of PE and PP, various polyamides such as for example PA6 or PA66, copolymers of PA6 and PA66, PA12 or the like, or thermoplastic polyesters such as for example PET or PBT.

The core layer preferably also comprises a polymer material. In principle the core layer can comprise any polymer material, but a thermoplastic material is preferred for the above-specified reasons. In a particularly preferred embodiment the core layer comprises a foam. In that respect the term foam is used to denote a polymer material, the structure of which is formed by pores. In a further preferred embodiment the core layer forms an integral foam, that is to say it has a substantially closed outer skin and a porous core.

The use of high-temperature thermoplastic materials such as for example polyphenylene sulfide (PPS), polyetheretherketone (PEEK) or polysulfone (PSU) in the core and/or the cover layer has also proven desirable.

It has been shown that the mechanical properties of the core layer can be improved if the polymer material additionally contains filler and/or reinforcing substances. They can preferably be CaCo₃, talcum, TiO₂, short fibers, discontinuous long fibers of glass or carbon or natural fibers.

The core layer and the cover layers are preferably so selected that the core layer is compatible with the first and/or the second cover layer. The term compatible materials is used to denote all materials which fuse together under pressure and/or with an increase in temperature or which can be joined together by virtue of a chemical reaction.

It has proven to be particularly advantageous for the cover and core layers to be selected from the same base material, that is to say the same polymer material, in which case the fillers or fibers possibly introduced into the cover and/or core layer can differ.

In principle it is also possible to use non-compatible materials, in which case preferably prior to step c) a bonding film is applied to the first and/or second cover layer. The term bonding film is used to denote a film compatible with both the layers between which it is introduced. Such a bonding film can for example comprise two layers produced by means of co-extrusion, wherein the first layer is compatible with the cover layer while the other layer is compatible with the core layer.

For many situations of use it may be advantageous if the core layer and/or the cover layer comprise bioplastic material (possibly plus reinforcing and/or filler substances). Particularly good results are achieved with polylactic acid (PLA), in which respect however it is also possible to conceive of sandwich structures in which the base material comprises starch, starch blends, polyhydroxybutyric acid (PHB) or cellulose acetates. In that case biologically degradable fibers and/or fillers are advantageously also used.

In a particularly preferred embodiment the first and/or the second cover layer differ from the core layer in a chemical and/or physical property.

Thus for example the cover layer can involve a much higher level of ductility or density than the core layer, which imparts to the sandwich structure overall a greater degree of shock resistance.

Surprisingly the described method functions even when the first and/or the second layer is introduced without preheating into the injection molding mold. In a preferred embodiment therefore preheating is omitted, which further simplifies the production procedure.

In a further particularly preferred embodiment step d) comprises the steps:

d1) injecting the core material into the closed injection molding mold between the first and the second cover layers by means of injection molding under pressure, and

d2) increasing the volume of the cavity of the injection molding tool.

That method makes it possible in a simple fashion to produce an integral foam, wherein firstly the core material is injected under high pressure. The injection molding tool is of such a configuration that the volume of the cavity can be altered. After the material intended for the core layer has been injected the volume of the cavity is increased. The result of this is that the core regions of the core layer have pores.

In a preferred embodiment the core layer is thus produced with a compacted edge region so that the density of the core layer in the compacted edge region is greater than in the center of the core layer.

In a preferred embodiment the proportion of pores in the compacted edge region is less than 2%, preferably less than 1% and particularly preferably less than 0.5%.

In an alternative embodiment the density of the compacted edge region is at least 90% of the density of the polymer material used for the core layer.

In regard to the structure the above-specified object is attained by a sandwich structure comprising a core layer and two cover layers arranged on oppositely disposed sides of the core layer, wherein the core layer in turn comprises a central core region and two edge regions arranged on oppositely disposed sides of the core region, the edge regions being of higher density than the core region.

In a preferred embodiment the density in the edge regions is greater than the density of the core region at least by 50%, preferably at least 100% and particularly preferably at least 300%.

The first and second cover layers preferably comprise the same material and particularly preferably are of substantially the same thickness.

In addition at least one cover layer and/or the core layer comprises a polymer material, preferably a thermoplastic material and particularly preferably a fiber plastic composite.

In a preferred embodiment the sandwich structure is of a thickness of at least 4 mm. The core layer is preferably at least 3 mm in thickness.

In a preferred embodiment the cover layer is of a thickness of between 0.3 and 2 mm. The core layer is of a thickness of preferably between 8 and 30 mm, wherein the compacted edge region is preferably of a thickness between 0.3 and 1.5 mm.

Further advantages, features and possible uses of the present invention will be apparent from the description hereinafter of a preferred embodiment and the accompanying Figure in which:

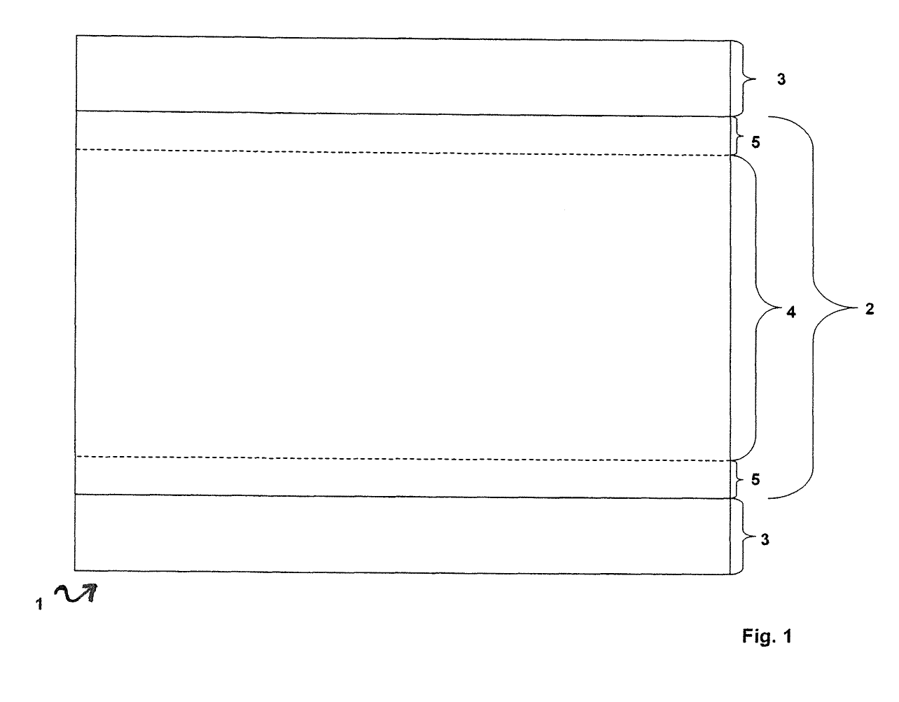

FIG. 1 shows a diagrammatic view of an embodiment of the sandwich structure according to the invention, and

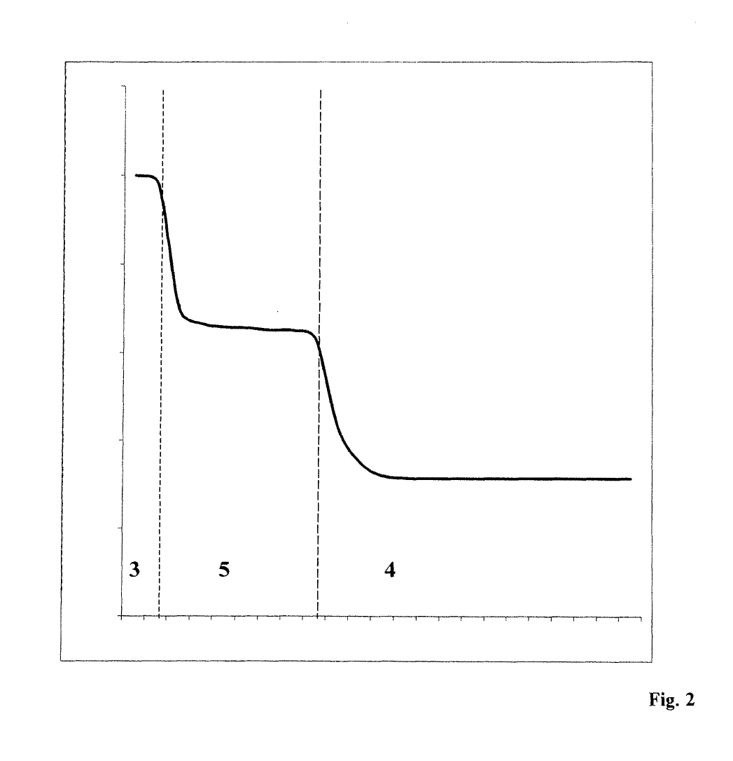

FIG. 2 shows a diagrammatic plotting of the density in relation to the spacing relative to the surface of the sandwich structure.

FIG. 1 diagrammatically shows the sandwich structure 1 according to the invention. It comprises a core layer 2 and two cover layers 3 arranged on both sides of the core layer 2.

The core layer 2 in turn comprises a core region 4 and compacted edge regions 5.

The density of the sandwich structure is not homogeneous. The configuration can be diagrammatically seen in FIG. 2. Shown there is a line graph illustrating density in dependence on the spacing relative to the surface (in each case in arbitrary units).

In that respect FIG. 2 shows at the left the density at the surface of the sandwich structure and at the right the density in the core region of the core layer.

It will be seen that the sandwich structure 1 is of the greatest density in the region of its cover layers 3 and it initially drops severely at the transition to the compacted edge region 5 of the core layer. Within the compacted edge region the density falls only slightly in the direction of the interior of the structure. At the transition from the compacted edge region 5 to the core region of the core layer the density again falls seriously and approaches a substantially constant low density in the center of the sandwich structure 1. The density in the compacted edge region 5 of the core layer 2 is much higher than the density in the core region 4. In other words the density alters abruptly twice from the outside inwardly.

In principle it would be possible for the density of the cover layer also to be less than the density of the compacted edge region.

By virtue of the method according to the invention it is possible to produce a sandwich structure which has very good mechanical properties. In addition it is possible for the production process to be easily adapted to the demands involved. Thus for example the thickness and the nature of the cover layer can be easily altered without having to alter the tool.

### LIST OF REFERENCES

1 sandwich structure
2 core layer
3 cover layer
4 core region
5 compacted edge region

1. A method of producing a sandwich structure (1) which has the following steps:
a) introducing a first cover layer (3) into an injection molding mold,
b) introducing a second cover layer (3) into the injection molding mold,
c) closing the injection molding mold,
d) injecting a core material into the closed injection molding mold between the first and second cover layers (3) by means of injection molding,
e) hardening of the core material so that a core layer (2) is formed between the two cover layers (3), and
f) opening the injection molding mold and removing the sandwich structure (3) from the mold.

2. A method as set forth in claim 1 characterised in that the first and second cover layers (3) are selected from the same material.

3. A method as set forth in claim 1 or claim 2 characterised in that the first and second cover layers (3) are of substantially the same thickness.

4. A method as set forth in one of claims 1 through 2 characterised in that the first and/or the second cover layer (3) comprises a polymer material, preferably a thermosetting or thermoplastic material and particularly preferably a thermoplastic material.

5. A method as set forth in one of claims 1 through 2 characterised in that the first and/or the second cover layer (3) comprises a fiber plastic composite.

6. A method as set forth in one of claims 1 through 2 characterised in that the core layer (2) comprises a polymer material, preferably a thermosetting or thermoplastic material and particularly preferably a foam.

7. A method as set forth in one of claims 1 through 2 characterised in that the core layer (2) is compatible with the first and/or second cover layer (3).

8. A method as set forth in one of claims 1 through 2 characterised in that prior to step c) a bonding film is applied to the first and/or second cover layer (3).

9. A method as set forth in one of claims 1 through 2 characterised in that the first and/or the second cover layer (3) differs from the core layer (2) in a chemical or physical property.

10. A method as set forth in one of claims 1 through 2 characterised in that the first and/or the second cover layer (3) is introduced without preheating into the injection molding mold.

11. A method as set forth in one of claims 1 through 2 characterised in that step d) comprises the steps:
d1) injecting core material into the closed injection molding mold between the first and second cover layers (3) by means of injection molding, and
d2) enlarging the volume of the cavity of the injection molding tool.

12. A method as set forth in claim 11 characterised in that the core layer (2) is produced with a compacted edge region (5), wherein the density of the core layer (2) in the compacted edge region (5) is greater than in the center of the core layer (2).

13. A method as set forth in claim 12 characterised in that the proportion of pores in the compacted edge region (5) is less than 2%, preferably less than 1% and particularly preferably less than 0.5%.

14. A method as set forth in claim 12 characterised in that the density of the compacted edge region (5) is at least 90% of the density of the polymer material used for the core layer (2).

15. A sandwich structure (1) comprising a core layer (2) and two cover layers (3) arranged on oppositely disposed sides of the core layer (2), characterised in that the core layer (2) in turn comprises a central core region (4) and two edge regions (5) arranged on oppositely disposed sides of the core region (4), wherein the edge regions (5) are of higher density than the core region (4).

16. A sandwich structure (1) as set forth in claim 15 characterised in that the density in the edge regions (5) is greater than the density of the core region (4) at least by 50%, preferably at least 100% and particularly preferably at least 200%.

17. A sandwich structure (1) as set forth in claim 15 or claim 16 characterised in that the first and second cover layers (3) comprise the same material and are preferably substantially of the same thickness.

18. A sandwich structure (1) as set forth in one of claims 15 through 16 characterised in that at least one cover layer (3) and/or the core layer (2) comprises a polymer material, preferably a thermoplastic material and particularly preferably a fiber plastic composite.

19. A sandwich structure (1) as set forth in one of claims 15 through 16 characterised in that the core layer (2) is compatible with the first and/or second cover layer (3).

20. A sandwich structure (1) as set forth in one of claims 15 through 16 characterised in that a bonding film is arranged between at least one cover layer (3) and the core layer (2).

21. A sandwich structure (1) as set forth in one of claims 15 through 16 characterised in that the first and/or the second cover layer (3) differs from the core layer (2) in a chemical or physical property.
